(19) United States
(12) Patent Application Publication
(10) Pub. No.: US 2009/0183347 A1
(43) Pub. Date: Jul. 23, 2009

(54) CARABINER

(76) Inventor: David L. Abels, Chapel Hill, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 12/016,275

(22) Filed: Jan. 18, 2008

(51) Int. Cl. F16B 45/02

(52) U.S. Cl. 24/599.6; 24/599.1

(57) ABSTRACT

A carabiner provided with a load bearing apex portion having a rubber sleeve for preventing side-to-side slippage of said carabiner on a rounded handle of a mobile vehicle such as a stroller or shopping cart.

### BACKGROUND OF THE INVENTION

1. Field of the Invention

This invention relates to a carabiner, and more particularly, to a carabiner in the form of a C-shaped structure having an articulated gate member which may be opened and closed to form a secure, hook-like hanger or carrier for a plurality of articles.

2. Description of the Prior Art

Carabiners have long been used in climbing, for example, to hang and hold ropes from used in the climbing process, as shown for example shown in U.S. Pat. Nos. 4,095,316; 4,811,467; 5,005,266; 5,329,675; and 6,606,769; and 6,622,354.

Recently, the function of a carabiner has been expanded to hang articles from a clothing belt, such as keychains, restrain dogs on a leash, or even hang packages, diaper bags, camera bags, or shopping bags from a mobile vehicle such as a baby stroller, shopping cart, or the like, having a cylindrical handle. However, the carabiner has the tendency to slip from side to side on the handle, under the weight of the article being hung from the carabiner and/or because of the motion imparted to the held article. While U.S. Pat. No. 6,606,769 shows a webbing sewn around the bottom straight portion of a carabiner to preclude slippage of an article, such as a dog leach strap attached to it, it does not teach the use of an anti-slip device on a carabiner attached to a cylindrical or tubular handle on which the carabiner is mounted or attached. Such a device would preclude shifting of the load held on the carabiner and damaging the load and possibly hitting a child in the stroller or shopping cart or the person using the mobile vehicle.

### SUMMARY OF THE INVENTION

Accordingly, it is the object of this invention to provide an economical, simple to manufacture, easily adjustable, non-slip device on an apex, or load supporting portion of a carabiner which is adapted to be hung universally on different types of round-handled carriers in order to provide security and safety for a person needing to hang items from the carrier.

This is accomplished by forming the carabiner with an apex on the upper end of the C-shaped, gated carabiner, forming a discrete load bearing surface for hanging the carabiner from a rounded handle on the carrier and covering the apex with a non-slip rubber sleeve. The sleeve fits over the apex of the carabiner, which then hangs on the carrier handle and with the hung load, frictionally prevents side to side movement of the carabiner along the handle. In one specific embodiment, the sleeve extends substantially to the pivot of the hinge of the carabiner, to ensure its extended frictional engagement with the support member on which the carabiner is reposed.

Alternatively, the sleeve can extend from the apex adjacent the gated member to cover the other leg of the C-shaped carabiner to prevent non-slippage of the items hung on the carabiner.

In another embodiment, the rubber sleeve can also be provided with finger grips, so the carabiner may function as a carrying handle or used in the conventional manner to hang articles, but with a finger grip at the apex to prevent slippage as the finger grip “cups” the handle.

Of course, it is possible to use the carabiner on handled carriers whose handles are non-rounded or provided with irregular shapes, such as pegs mounted on a wall and the non-slip material may be a suitable plastic. Even a knurled surface formed on the underlying metal of the carabiner is within the scope of the invention.

### BRIEF DESCRIPTION OF THE DRAWINGS

FIG. 1 is a perspective view of the carabiner of the present invention;

FIG. 2 is a cross-sectional view of the carabiner of FIG. 1 taken substantially along the plane indicated by line 2-2 of FIG. 1;

FIG. 3 is a perspective view of the carabiner of FIG. 1 in open position;

FIG. 4 is a front view in elevation of the gate member of the carabiner of FIG. 3;

FIG. 5 is a perspective view of an alternative embodiment of the carabiner of FIG. 1 with the non-slip sleeve surrounding the apex and opposite leg of the carabiner;

FIG. 6 is a side view in elevation of still another embodiment of the carabiner of the present invention, which can be used as a carrying handle;

FIG. 7 is a perspective view of the carabiner of FIG. 1 in use on a rounded handle of a shopping cart or stroller; and

FIG. 8 is a perspective view of the carabiner of FIG. 6 illustrated as being used as a carrying handle.

### DETAILED DESCRIPTION OF THE PREFERRED EMBODIMENTS

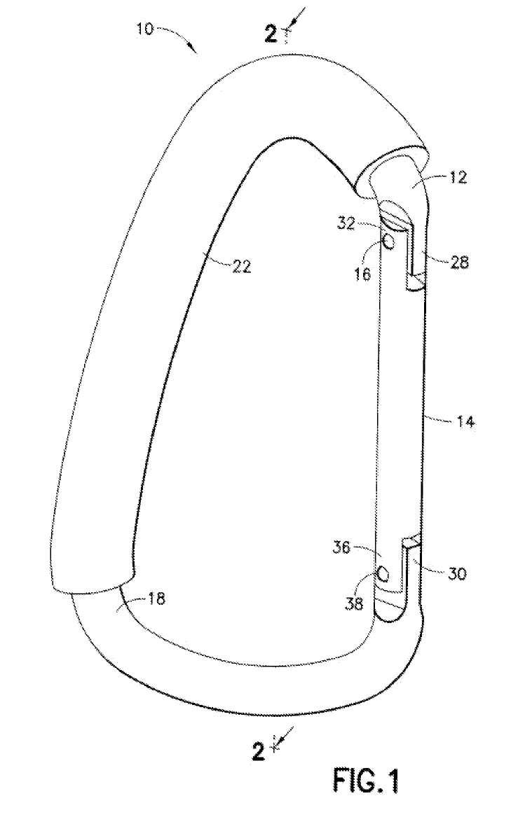

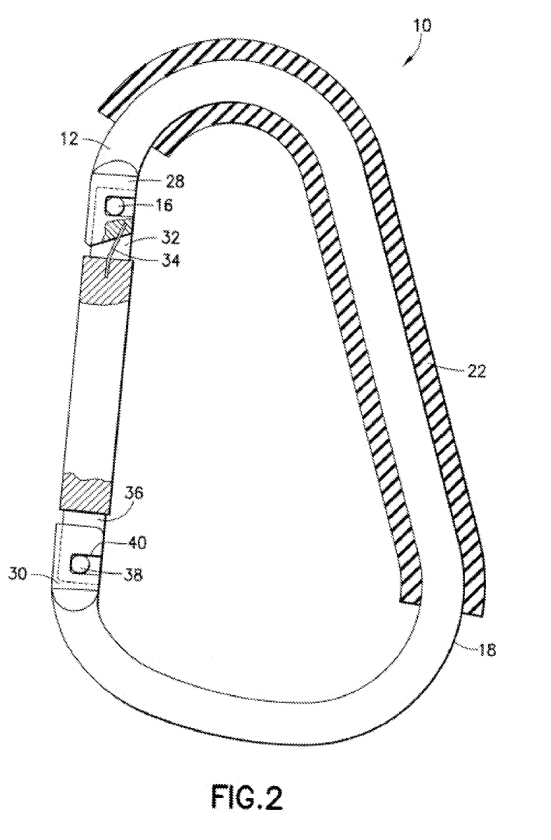

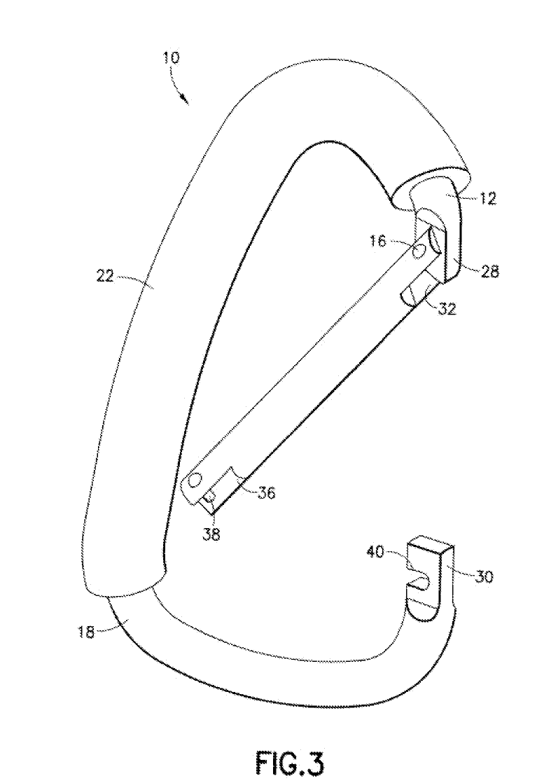

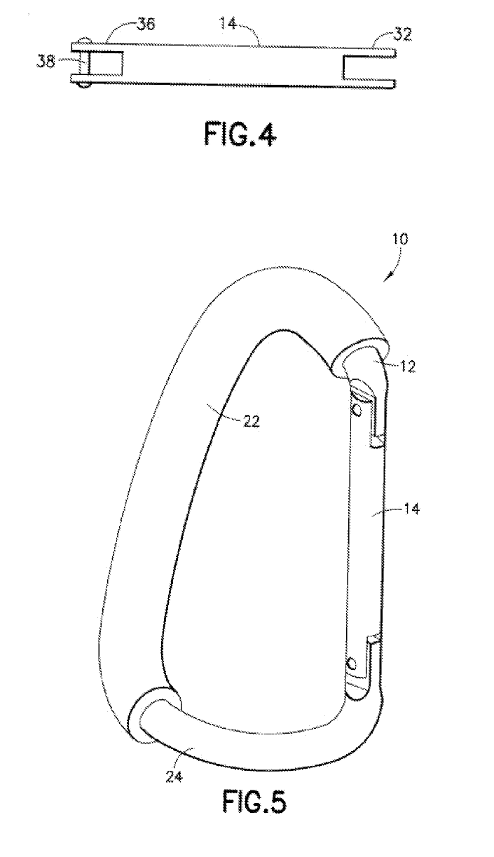

Referring now to the drawings in detail, wherein like numerals indicate like elements throughout the several views, FIG. 1 illustrates one embodiment of the carabiner 10 of the present invention.

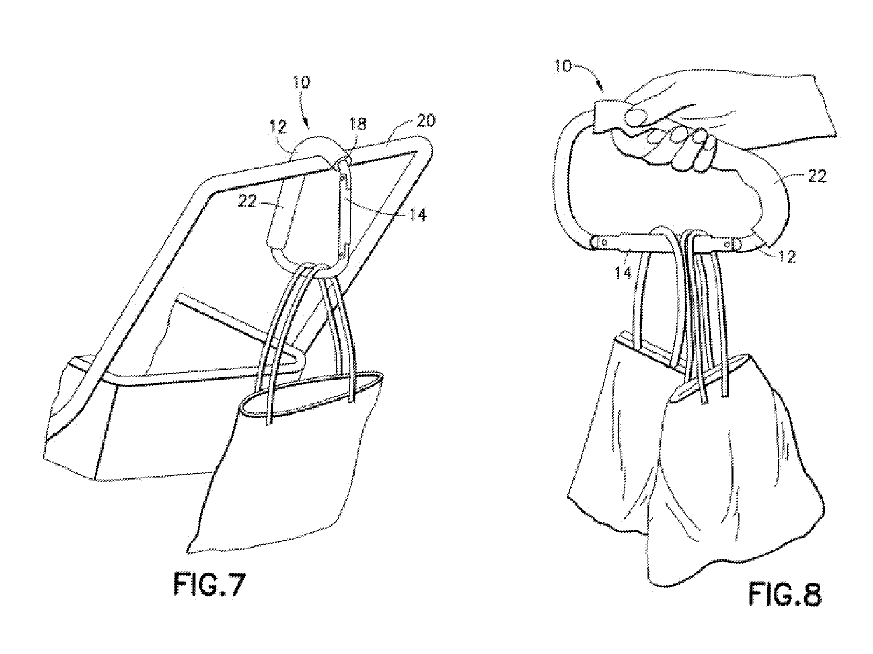

As shown, carabiner 10 is formed of an essentially C-shaped member 12, and includes a gate member 14, articulated about a pivot pin 16. C-shaped member 12 and gate member 14, when gate member 14 is in closed position as indicated in FIG. 1 are generally oval in configuration, except that the upper portion of C-shaped member 12 is formed with a rounded, shortened, apex portion 18 to serve as a load-bearing surface when the carabiner 10 is hung on a rounded handle 20, as indicated in FIG. 7.

A rubber sleeve 22 extends about the C-shaped member 12 from a point adjacent to pivot pin 16 and encompassing at least the apex portion 18 of the member 12 as shown in FIG. 1. The sleeve 22 when the carabiner 10 is hung from a rounded handle 20, generates sufficient friction under load to preclude side-to-side movement of the carabiner 10 on the handle 20.

If desired, the sleeve 22 can extend about the bottom portion 24 of the C-shaped member 12 to further preclude slippage of the items loaded onto this portion of the carabiner 10, as shown in FIG. 5.

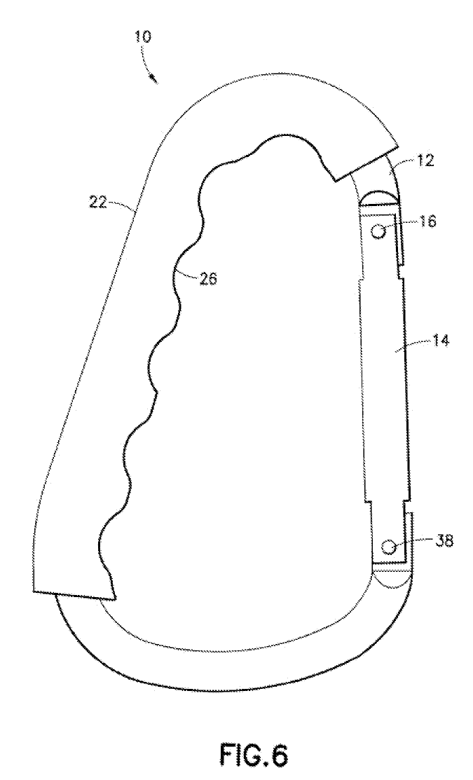

Further, as shown in FIGS. 6 and 8, the carabiner 10 may be used as a carrying handle in its own right, by providing finger grips or indentations 26 in the sleeve 22.

During manufacture, the sleeve 22, may be slid on the apex portion 18 by opening the articulated gate member 14, by pivoting the member 14 inwardly about pivot pin 16 and sliding the sleeve 22 along the tubular or cylindrical gate member 14, until fully seated on the C-shaped member 12. The upper and lower opposed ends 28, 30, respectively, of the C-shaped member 12 are flattened to receive the tubular end 32 of gate member 14 and pivot pin 16 therethrough. A leaf spring 34 is received in tubular end 32 and in the end 28 of C-shaped member 12 on a bias or angle between the ends 28,30 so that when the gate member is opened inwardly about the pivot pin 16, the leaf spring 34 will exert a force on the tubular gate to return it to a closed position where the opposite end 36 having a pin 38 therethrough of the tubular gate member 14 is received beneath a flattened hook 40 extending above end 30 of C-shaped member 12 to latch the gate member 14 in closed position under the urging of leaf spring 34.

1. A carabiner comprising:
a substantially C-shaped member having an opening between the opposed ends of said C-shaped member defining a gate opening across the opening;
a gate member pivotally attached at one end thereof to one end portion of said C-shaped member to open and close said opening for access to the interior of said C-shaped member, whereby one or more articles may be hung from an interior surface of said C-shaped member;
said C-shaped member having a rounded, shortened apex portion adjacent one end thereof for mounting said C-shaped member on a supporting surface; and
a friction producing surface on at least said apex portion of said C-shaped member for precluding side-to-side movement of said C-shaped member on said supporting surface.

2. The carabiner of claim 1 wherein said friction producing surface is provided by a rubber sleeve received on said apex portion of said C-shaped member.

3. The carabiner of claim 2 wherein said rubber sleeve extends from said apex portion to substantially the opposed end of said C-shaped member.

4. The carabiner of claim 3 wherein said rubber sleeve has a number of finger grips formed therein whereby said C-shaped member may be rotated relative to said apex portion and used as a carrying handle.

5. The carabiner of claim 2 wherein said rubber sleeve has a number of finger grips formed therein whereby said C-shaped member may be rotated relative to said apex portion and used as a carrying handle.

6. The carabiner of claim 2 wherein the opposed ends of said C-shaped member has a latch mechanism for retaining said gate member in closed position across said opening.

7. The carabiner of claim 6 wherein said latch mechanism includes a leaf spring between one end of said C-shaped member adjacent said apex portion and said gate member for biasing said gate member to a closure position across said opening in said C-shaped member, and a hook on the other end of said C-shaped member open in the direction of the interior of said C-shaped member for receiving a pin on the other end of said gate member under the bias of said gate member by said leaf spring.

8. The method enabling the use of a carabiner to hang items from a device with a rounded handle comprising the steps of:
(a) providing a carabiner with a load bearing, rounded, apex portion; and
(b) forming a non-slip surface on said apex portion to preclude side-to-side movement of the carabiner when said rounded apex portion is hung on the rounded handle of the device.

9. The method of claim 8 wherein said non-slip surface is formed by a rubber sleeve on said apex portion of the carabiner.

10. The method of claim 9 wherein the rubber sleeve on said apex portion of the carabiner includes a finger grip to cup the apex portion to provide additional preclusion of side-to-side movement.

11. A carabiner according to claim 1, wherein the friction producing surface extends substantially to a pivot structure of the gate member, for extended engagement thereof with a support surface on which the carabiner reposes in use.

12. A carabiner comprising:
a substantially C-shaped member having an opening between the opposed ends of said C-shaped member defining a gate opening across the opening;
a gate member pivotally attached at one end thereof to one end portion of said C-shaped member to open and close said opening for access to the interior of said C-shaped member, whereby one or more articles may be hung from an interior surface of said C-shaped member;
said C-shaped member having a rounded, shortened apex portion adjacent one end thereof for mounting said C-shaped member on a supporting surface; and
a friction producing surface extending around the apex portion of the C-shaped member and substantially to the gate member, for precluding side-to-side movement of said C-shaped member on said supporting surface.

13. The carabiner of claim 12, wherein the friction producing surface is provided by a rubber sleeve.

14. The carabiner of claim 13, wherein the rubber sleeve extends substantially around the full extent of the C-shaped member.

15. An attachment system comprising:
a substantially C-shaped member having an opening between the opposed ends of said C-shaped member defining a gate opening across the opening;
a gate member pivotally attached at one end thereof to one end portion of said C-shaped member to open and close said opening for access to the interior of said C-shaped member, whereby one or more articles may be hung from an interior surface of said C-shaped member;
said C-shaped member having a rounded, shortened apex portion adjacent one end thereof for mounting said C-shaped member on a supporting surface; and
a positional retention element arranged at the apex portion of said C-shaped member along the supporting surface and adapted to prevent side-to-side movement of the carabiner relative to the supporting surface.

16. The attachment system of claim 15, wherein the positional retention element comprises a friction producing surface.

17. The attachment system of claim 15, wherein the positional retention element is fitted over or around the apex portion.

18. The attachment system of claim 15, wherein the positional retention element comprises a sleeve adapted to engage the apex portion.

19. The attachment system of claim 15, wherein the supporting surface is along or associated with a cylindrical or tubular handle of a baby stroller or shopping cart.

20. A method enabling the use of a carabiner to hang items from a device with a rounded handle having an associated supporting surface, wherein the carabiner has a load bearing, rounded apex portion, the method comprising providing a positional retention element between the apex portion and the supporting surface, wherein the positional retention element is adapted to prevent side-to-side movement of the carabiner relative to the supporting surface.

21. The method of claim 20, wherein the positional retention element comprises a friction producing surface.

22. The method of claim 20, wherein the positional retention element is fitted over or around the apex portion.

23. The method of claim 20, wherein the positional retention element comprises a sleeve adapted to engage the apex portion.
